(19) United States
(12) Patent Application Publication
(10) Pub. No.: US 2010/0203486 A1
(43) Pub. Date: Aug. 12, 2010

(54) Social and Physical Activity Meter, an apparatus and method

(76) Inventor: Igor Nabutovsky, Bet Shemesh (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/369,610

(22) Filed: Feb. 11, 2009

(51) Int. Cl. G09B 19/00

(52) U.S. Cl. 434/236

(57) ABSTRACT

The invention presents an apparatus, which measures, accumulates and stores the amount of the physical and social activity of the user. The activities are converted into points, which the user can exchange for beneficial goods. The physical activity is measured by a sensor, whose output signal is related to the user movement. The social activity is measured by means of estimating the number of similar apparatuses in the vicinity of the user. The present invention's goal is encouraging social and physical activity.

### FIELD OF THE INVENTION

The present invention relates to an apparatus and method which scores points for social and physical activities of particularly but not exclusively teenagers and children.

### BACKGROUND OF THE INVENTION

During the last years it is a common phenomenon to find children and young people spending most of their time facing a computer and a television screen.

The part of social and active games in children's lives has decreased.

Furthermore, the absence of physical activities, caused by avoiding “outdoor games”, may produce some “side effect” such as weight gaining—a well known problem of the western world.

Social, active and physical games are essential and inseparable parts in children's social and physical development.

These games help in building the child's personality, developing creativity, self confidence, team work, leadership and other abilities, preparing him towards adulthood. Moreover, the games provide the child a healthy way of life, both mental and physical.

The present invention will encourage users, especially children and teenagers to participate in social, physical and mobile activities. This will be achieved by using a scoring points method.

The social and physical activity meter scores regarding the amount of social and physical activities. Presenting in surroundings of another similar apparatuses, scores the user for social activity. Doing physical activities scores the user for physical activity. Social and physical activities combination accelerates scoring.

The concept of scoring point for social and physical activities will encourage young to participate in “the real world games” and spend more time with real, and not only virtual friends.

It will also decrease their time spent in front of the computer and the television.

It can also be assumed that the young's urge to score more points than their friends, will lead them to a more social and active life.

In order to encourage children to be more socially and physically activated, the scores can be used as a payment for different “purchases”.

Parents can exchange the points scored by their children with computer and television time, playing time, goods and even pocket money;

Companies and factories, whose interest is in encouraging social and physical activities, may recognize the scores as a payment for their goods;

Moreover, the scores can be recognized by the ministry of education for studies' benefits.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

The present invention innovates in a social and physical activity meter apparatus (to be called SPAM), for measuring and scoring young's social and physical activities. The total score depends on the activity intensity. The user can exchange the points he scored into beneficial goods. More points mean more goods. This method encourages young people towards social and physical activity.

The apparatus is a portable one and can be used as a stand-alone or as a part of other electronic devices like: mobile communication devices, portable media players, hand watches, etc.

The social and physical activity meter is attached onto the user's body or cloth by an attachment means or carried as a pocket device.

The apparatus has a case. The case may contain an attachment means for attaching the apparatus onto the user's body or cloth.

The apparatus, further, includes:
a. a physical activity sensor providing an output signal related to the user's movement.
b. a transmitter that transmits a signal for the purpose of communication and data transmitting. The data includes, among others, its device ID.
c. a receiver that receives communication signals and data from other electronic equipment, including other SPAMs.
d. storing means intended for storing, among others, the:

device ID, output value of the physical activity sensor, the number of neighbor SPAMs (i.e—the SPAMs whose signal was received by the said SPAM), physical activity of the neighbor SPAMs.
e. a microprocessor.
f. an electrical power source.

The microprocessor is programmed to estimate the score based on:
a. number of neighbor SPAMs.
b. physical activity from sensor output.
c. physical activity transmitted by neighbor SPAMs.

### BRIEF DESCRIPTION OF THE DRAWINGS

The accompanying drawings, which are incorporated inside and form a part of this specification, illustrate embodiments of the invention and together with the description, serve to explain by way of example only, the principles of the invention:

FIG. 1 is a functional block diagram of the social and physical activity meter;

FIG. 2 is a flow chart that illustrates the operation of the social and physical activity meter;

FIG. 3 is a flow chart that illustrates the Sensor's Sampling Algorithm;

FIG. 4 is a flow chart that illustrates the Score Calculation Algorithm;

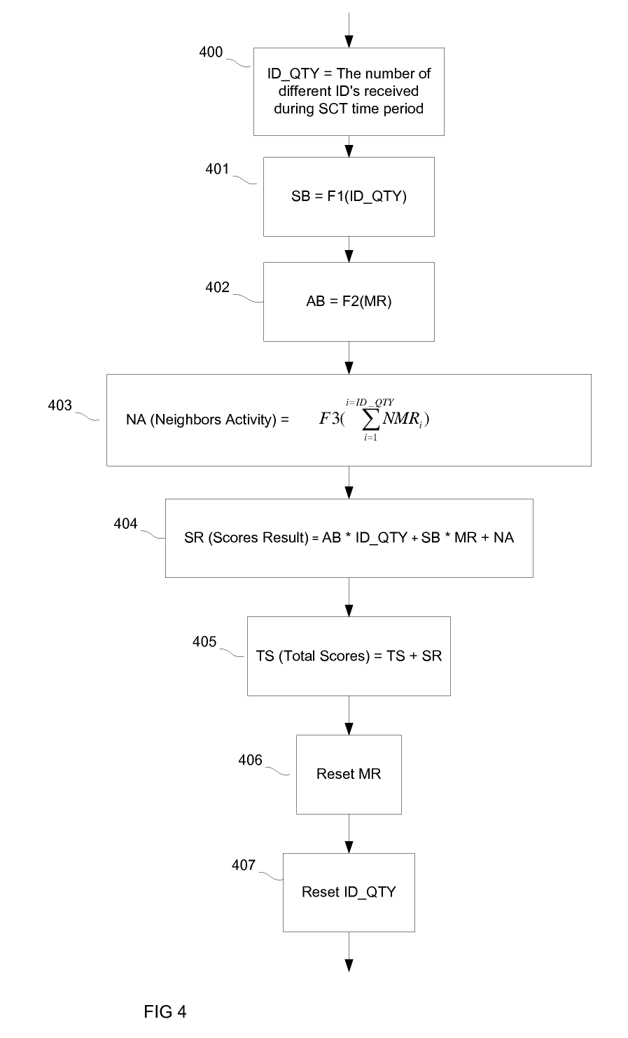

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

The social and physical activity meter (to be called SPAM) may be implemented as a stand-alone device or as a part of another electronic device, for example: mobile cellular phone, portable media player, hand watch etc. The social and physical activity meter is a pocket device or alternatively, has an attachment means for attaching the device to the user's body or cloth. The attachment means may be, for example, a watch strap for attaching the device case around the wrist of the user. Also, it may be a clip, for attaching the device to the user's cloth.

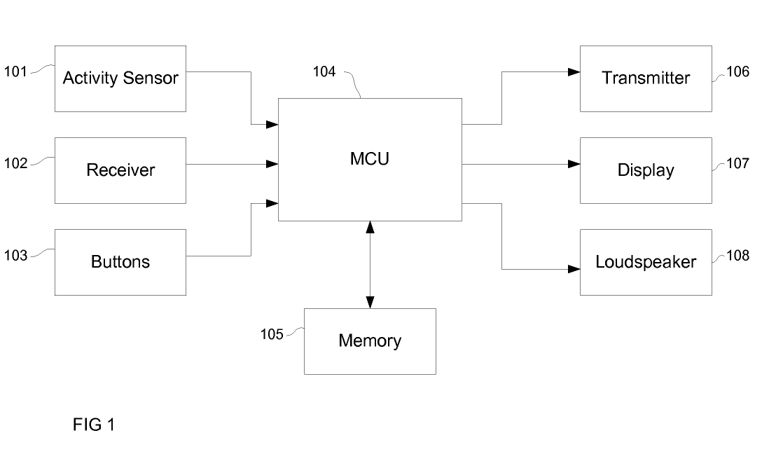

The device, as illustrated in FIG. 1, includes a physical activity sensor 101 for measuring the user's physical activity. The physical activity sensor may be any type of conventional sensor, employed to measure an amount of physical activity performed by a user. For example, the sensor 101 may be a single or multi axes accelerometer, configured to measure acceleration of user's body. The sensor may alternatively be a single or multi axes magnetometer configured to measure changes in the user's position in space. The sensor's output is connected directly or through a filter circuit and/or through data converters, like, Analog to Digital or Analog to PWM (Pulse Width Modulation) Converters, to the Main Control Unit—the MCU 104.

The filter is a low pass filter, which may be implemented as a hardware circuit or a software digital filter in the MCU program. It should filter signals containing no information about the user's activity, due to their high frequency nature, that is beyond the frequencies that the user's physical activity may produce.

SPAM includes a receiver 102 that receives communication signals and data from other electronic equipment, including other SPAMs. The received data includes among others: ID of other SPAMs, physical activity data of other SPAMs, configuration commands.

SPAM includes a transmitter 106 that transmits communication signals and data to other electronic equipment, including other SPAMs. The transmitted data includes among others: ID of the said SPAM, physical activity data of the said SPAM, stored data including score, internal registers' value.

The receiver 102 and transmitter 106 communicate by using one or few types of conventional wireless protocols and modulation methods, such as AM, FM, Bluetooth, ZigBee, WiFi, Infrared.

The SPAM includes a storing means, 105, or in other words a memory. The memory stores among others: ID of the SPAM, ID of neighbor SPAMs, i.e. the SPAMs that their signal was received by the said SPAM. In addition, the memory stores the intermediate results of the calculations for the score estimation, the score itself, samples of the physical activity sensor and physical activity of the neighbor SPAMs.

As noted above, the apparatus includes a main control unit, the MCU 104. The MCU 104 may be implemented as a microcontroller, FPGA (Field Programmable Gate Array) or dedicated ASIC. The MCU 104 is programmed to perform various functions in different operating modes. As a primary function, the MCU 104 is programmed to calculate a score for the user's social and physical activity. It is done by estimating the amount of physical activity as measured by the physical activity sensor, by counting the number of neighbor SPAMs and by their physical activity as transmitted by them and received by the said SPAM. The scoring method will be discussed in more details below.

Various embodiments of the social and physical activity meter may optionally include a display 107, a loudspeaker 108 and a means of buttons 103.

The display 107 may be any type of conventional display. For example, the display 107 may employ a full color liquid crystal display screen, or monochromatic liquid crystal display screen. The display 107 can be configured to provide the following indications: amount of the measured physical and social activity at the current moment, accumulated scores, device menus, special graphic effects when a predefined score is reached.

In some embodiments the displayed data, the apparatus mode, the configuration definitions etc. can be selected by the buttons 103 that are connected to the MCU 104. An alternative way for user control is by sending control commands from an electronic device, a computer for instance. The receiver 102 will receive the commands from the device and pass them to the MCU 104. The MCU 104 is programmed to execute commands, which were received from a trusted electronic device only, i.e. a device whose ID is stored in the SPAM's memory 105 and marked as a trusted device.

Some embodiments may also include a loudspeaker 108 for generating audio signals and special sound effects during the SPAM's operation and when a predefined score is reached.

The apparatus includes a power supply source, which may be primary (non rechargeable) battery or secondary (rechargeable) battery. Some embodiments may also include energy transfer means, for example photovoltaic cells. The embodiment may also include software and hardware means for decreasing power consumption, which may activate a “sleep”, a “power down” mode or even cut off modules and components that are not vital in a specific moment.

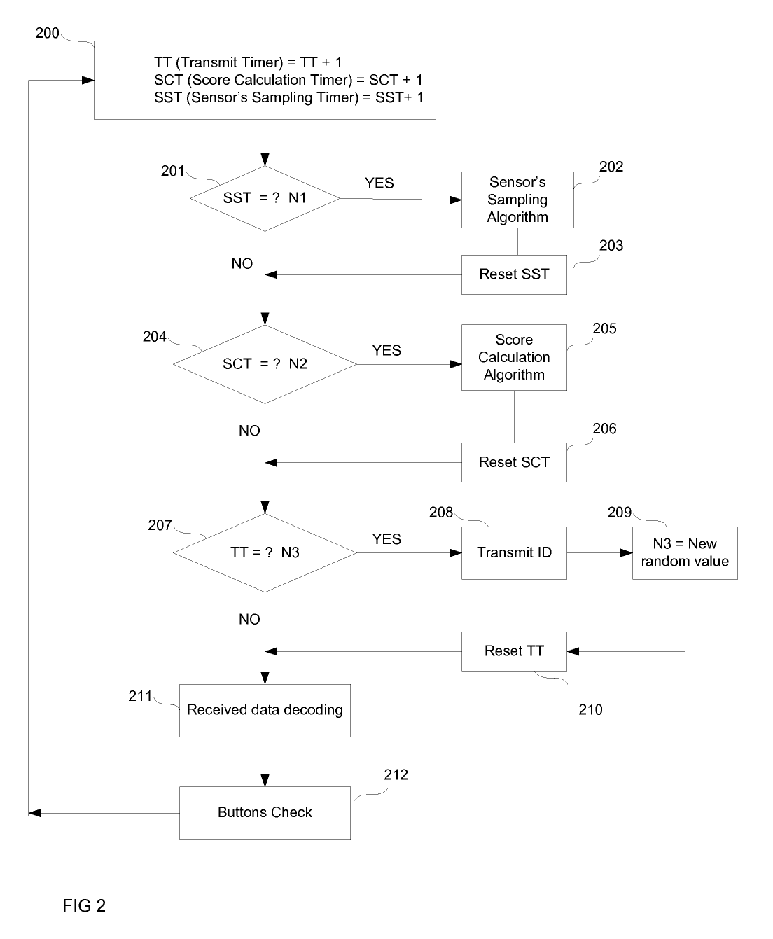

The MCU 104 executes a main algorithm in an infinite loop as shown on FIG. 2. The main algorithm executes sub-algorithms and other defined actions, like: sensor sampling algorithm 202, received data decoding 211, score calculation algorithm 205, ID transmit 208, buttons status check 212.

The MCU 104 operates at least three timers, step 200. When a certain timer counts up a defined value, the MCU 104 executes a suitable sub algorithm.

The timers are:

SST (Sensor's Sampling Timer)—When this timer reaches N1 counts, step 201, sensor sampling algorithm 202 is executed. N1 is a constant value that represents a time interval in the range of 1 msec to 100 msec.

SCT (Score Calculation Timer)—When this timer reaches N2 counts, step 204, score calculation algorithm 205 is executed. N2 is a constant value that represents a time interval in the range of 10 sec to 60 sec.

TT (Transmit Timer)—When this timer reaches N3 counts, step 207, the apparatus transmits, at least, its ID, step 208. The transmitted data may contain additional information, like current amount of physical activity, accumulated scores and others. N3 is random value that represents a time interval in the range of N2/2 to N2/3. The assignment of a random value to N3, step 209, is done sequentially after the ID transmission, step 208. Then, TT value is initialized, step 210. N3 is random in order to reduce the chance of collision between simultaneous ID transmissions of a few SPAM devices in the same area.

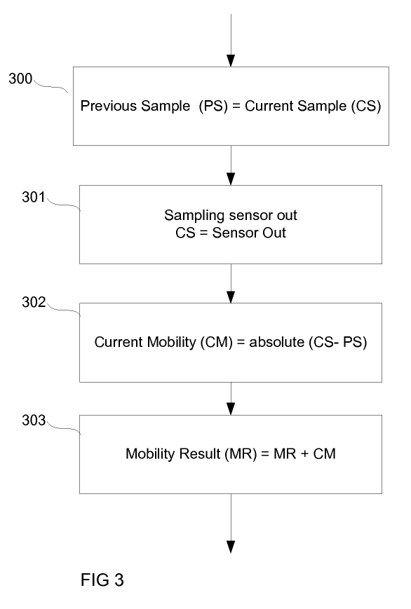

Each time the sensor's sampling algorithm is activated, as shown in FIG. 3, it acts as follows: the PS (Previous Sample) register's value is assigned to the CS (Current Sample) register, step 300. The sensor's output is sampled, converted into a numerical value and stored in the CS (Current Sample) register, step 301. The CS register is subtracted from the PS register and the absolute value of the result is stored in the CM (Current Mobility) register, step 302.

The CM register is summed with the MR (Mobility Result) register. The summation result is stored in the MR register, step 303. Actually, MR accumulates the CM values.

After the execution of the sensor's sampling algorithm, step 202, the SST is initialized to 0, step 203. The function decoding the received data, 211, works as follows: every received ID is stored in the memory 105. The way of processing the received data depends upon the sender type and the apparatus operation mode. For instance, if the received data is a configuration command and the sender's ID is not in the so-called “trusted list”, then the command will be discarded. On the other hand, if the sender's ID is in the “trusted list”, the received configuration command will be executed. If the received data contains information about the sender's activity, this information will be stored in the apparatus memory 105.

The score calculation algorithm 205 operates as follows:

The number of distinct IDs stored in memory 105 is assigned to the ID_QTY (ID Quantity) register's value, step 400.

F1, as shown in step 401, is a mathematical function which calculates a bonus for social activity—SB (Social Bonus).

The calculation is based on the ID_QTY register's value and its result will always be equal to or greater than 1.

F2, as shown in step 402, is a mathematical function which calculates a bonus for physical activity—AB (Activity Bonus). The calculation is based on the MR register value, which is calculated in step 303, and its result will always be equal to or greater than 1.

F3, as shown in step 403, is a mathematical function which summing the results of all the NMR (Neighbor Mobility Result) stored values. NMRI is a mobility result calculated and transmitted by a neighbor SPAM and received and stored by the said SPAM. F3's result will always be equal to or greater than 0.

The F3 function's result is stored in the NA (Neighbors Activity) register, step 403.

The calculation of the scores gained by the user in the N2 time interval is shown in step 404 and stored in the SR (Score Result) register. The sense of this calculation is: doing a physical activity in a social environment gaining more points rather then just doing a physical activity. Also, social activity in combination with a physical activity gaining more points rather then just a social activity. Moreover, being in an environment of physical active users, scores more points than environment of passive users. The current cycle score, SR, is summed with TS (Total Scores), which accumulates the SR results for all the cycles, step 405. Steps 406, 407 initialize the MR and the ID_QTY registers in order to allow a new activity estimation in the following SST cycle.

The TS register value is the total score gained by the user. This value may be displayed on the apparatus display 107. It may also be used for a benefit payment by, for example, transferring points from the SPAM to a collect device, a computer for instance. To make a transfer, the user should add the collect device's ID to the SPAM's “trust list” and initiate the points transfer. The transferred points will be subtracted from the TS value and added to the user's virtual account on the collect device. The user can surf to a dedicated Internet WEB site, which contains a list of offered benefits, and pay with points from the virtual account.

The social and physical activity meter checks periodically the buttons' status, 103. In case a button is pressed, a proper reaction will take place. For example, apparatus menu activation, navigation into the menu, change of display mode, marking the devices, whose IDs are stored in the SPAM's memory, as trusted etc.

What is claimed:

1. Apparatus that functions as a meter of social and physical activity (to be called later on: social and physical activity meter, or SPAM), comprising of:
a. means for storing the apparatus' ID.
b. a physical activity sensor providing an output signal related to the user movement.
c. a transmitter that transmits a communication signal and data, including, among others, its apparatus ID.
d. a receiver that receives communication signals and data from other electronic equipment, including other SPAMs.
e. means for distinguishing IDs of electronic equipment, whose signals were received by the said SPAM.
f. means for distinguishing and storing the number of neighbor SPAMs, i.e. the SPAMs that their signal was received by the said SPAM.

2. Apparatus claimed in 1, wherein it estimates physical and social activity scores based on the stored number of neighbor SPAMs and physical activity sensor output.

3. Apparatus claimed in 1, wherein it transmits also its physical activity data and has means to store the activity data of neighbor SPAMs.

4. Apparatus claimed in 3, wherein it estimates physical and social activity scores based on the stored number of neighbor SPAMs, the activity data of the neighbor SPAMs and its physical activity sensor output.

5. Apparatus claimed in 2, estimating the scores by accounting separately for the following:
a. the personal physical activity in the vicinity of other SPAMs.
b. the social activity, based on the stored neighbor SPAMs quantity, combined with the personal physical activity.

6. Apparatus claimed in 4 and 5, estimating the scores by additionally accounting for the physical activity of the neighbor SPAMs.

7. The apparatus as clamed in 1, may be implemented as a part of other electronic devices e.g. mobile communication devices, portable media players, hand watches, etc.

8. The apparatus as claimed in claim 1, including buttons for user control over the apparatus.

9. Apparatus as claimed in claim 1, including a screen, displaying among others the gained score.

10. Apparatus as claimed in claim 9, displaying, among others, special graphic effects when a predefined score is reached.

11. Apparatus as claimed in claim 1, generating audio signals during the device operation.

12. Apparatus as claimed in claim 11, generating special sound effects when a predefined score is reached.

13. Apparatus as claimed in claim 1, including attachment means for attaching the apparatus' case to the user's body or cloth.

14. Apparatus as claimed in claim 1, wherein the sensor is a magnetometer.

15. Apparatus as claimed in claim 1, wherein the sensor is an accelerometer.

16. Apparatus as claimed in claim 1, wherein
a. the physical activity sensor output is sampled and stored at a constant time interval T1.
b. the physical activity estimation, based on stored physical activity sensor output samples, is performed and stored at a constant time interval T2>T1.
c. the apparatus counts and stores the number of the received distinct neighbor SPAM device's IDs at each constant time interval T3≧T2.
d. the apparatus transmits its ID number at a variable and random time period T4≦T3/2.
e. the apparatus estimates physical and social activity scores, based at least on the self physical activity estimation and the neighbor SPAMs quantity, at a time period of T5≧T3.

17. The apparatus as claimed in claim 1, including means for storing so-called trust list. This list contains IDs of the electronic equipment that configuration commands received from them will be executed. Confidential data transmitted by the apparatus may be addressed only to electronic equipment, whose ID is stored in the trust list.

18. The apparatus as claimed in claim 1, includes a low-pass filter for filtering the output signal of the physical activity sensor.

19. The scores, accumulated by the apparatus as claimed in claim 2, may be admitted by companies as a payment for their goods and may serve the user to purchase beneficial goods.

20. An Internet WEB site, which offers goods that can be purchased by points gained by the apparatus as claimed in claim 2.
